(19) United States
(12) Patent Application Publication
(10) Pub. No.: US 2007/0062046 A1
(43) Pub. Date: Mar. 22, 2007

(54) Chisel having replaceable tip

(76) Inventor: Shin Jong Hsu, Taichung City (TW)

Correspondence Address: CHARLES E. BAXLEY, ESQ., 90 JOHN STREET, THIRD FLOOR, NEW YORK, NY, 10038, US

(21) Appl. No.: 11/231,688

(22) Filed: Sep. 21, 2005

(51) Int. Cl. B25D 3/00

(52) U.S. Cl. 30/167

(57) ABSTRACT

A chisel includes a handle, a tip removably mounted on the handle, an insertion rod secured to the tip and inserted into the handle, and at least one positioning unit mounted on the handle and releasably urged on the insertion rod to releasably position the insertion rod on the handle so that the tip is removably mounted on the handle. Thus, the chisel has replaceable tips, so that the handle can co-operate with tips of different types, thereby facilitating a user operating the chisel, and thereby enhancing the working efficiency. In addition, the user only has to carry a handle and a plurality of tips to construct the chisel without having to carry multiple chisels, thereby greatly decreasing the weight.

### BACKGROUND OF THE INVENTION

1. Field of the Invention

The present invention relates to a chisel, and more particularly to a chisel having a replaceable tip.

2. Description of the Related Art

A conventional chisel 10 in accordance with the prior art shown in FIG. 1 comprises a handle 11, and a tip 12 integrally formed on the handle 11. However, the tip 12 is integrally formed on and cannot be removed from the handle 11, so that the tip 12 cannot be replaced for different uses, thereby causing inconvenience to a user when operating the chisel, and thereby decreasing the working efficiency. In addition, the use has to carry multiple chisels for different uses, thereby greatly increasing the weight, and thereby occupying the space of storage.

### SUMMARY OF THE INVENTION

The present invention is to mitigate and/or obviate the disadvantage of the conventional chisel.

The primary objective of the present invention is to provide a chisel having a replaceable tip.

Another objective of the present invention is to provide a chisel that has replaceable tips, so that the handle can co-operate with tips of different types, thereby facilitating a user operating the chisel, and thereby enhancing the working efficiency.

A further objective of the present invention is to provide a chisel, wherein the user only has to carry a handle and a plurality of tips to construct the chisel without having to carry multiple chisels, thereby greatly decreasing the weight.

In accordance with the present invention, there is provided a chisel, comprising:

a handle;

a tip removably mounted on the handle;

an insertion rod secured to the tip and inserted into the handle;

at least one positioning unit mounted on the handle and releasably urged on the insertion rod to releasably position the insertion rod on the handle so that the tip is removably mounted on the handle.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a conventional chisel in accordance with the prior art;

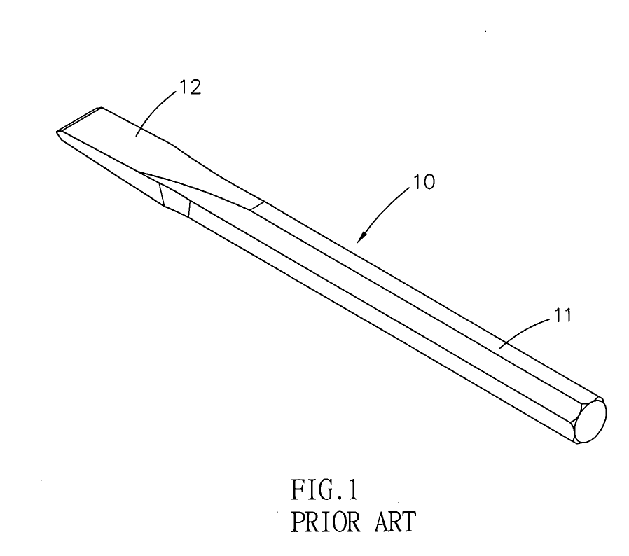

FIG. 2 is a perspective view of a chisel in accordance with the preferred embodiment of the present invention;

FIG. 3 is an exploded perspective view of the chisel as shown in FIG. 2;

FIG. 4 is a partially plan cross-sectional view of the chisel as shown in FIG. 2;

FIG. 5 is a partially exploded perspective view of the chisel as shown in FIG. 2;

FIG. 6 is a schematic operational view of the chisel as shown in FIG. 4;

FIG. 7 is a schematic operational view of the chisel as shown in FIG. 6;

FIG. 8 is a perspective view of a chisel in accordance with another preferred embodiment of the present invention;

FIG. 9 is a perspective view of a chisel in accordance with another preferred embodiment of the present invention; and

FIG. 10 is a perspective view of a chisel in accordance with another preferred embodiment of the present invention.

### DETAILED DESCRIPTION OF THE INVENTION

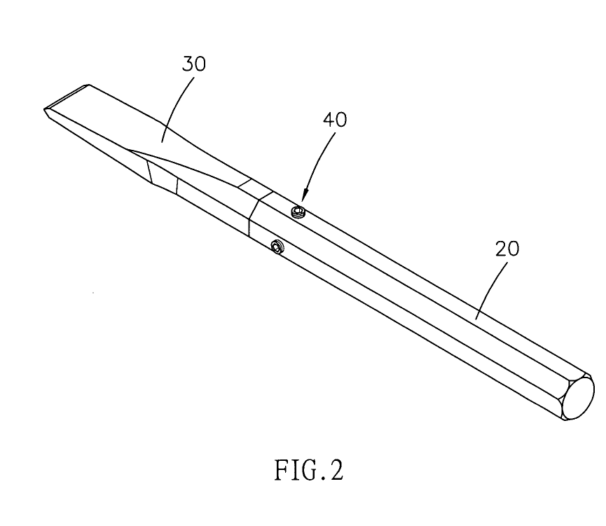

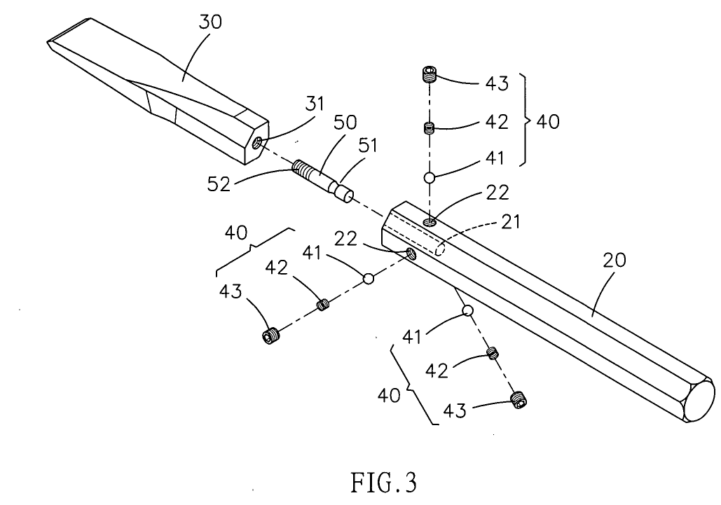

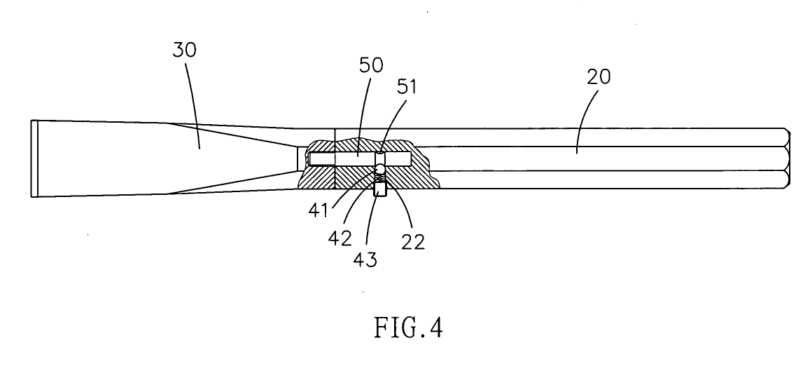

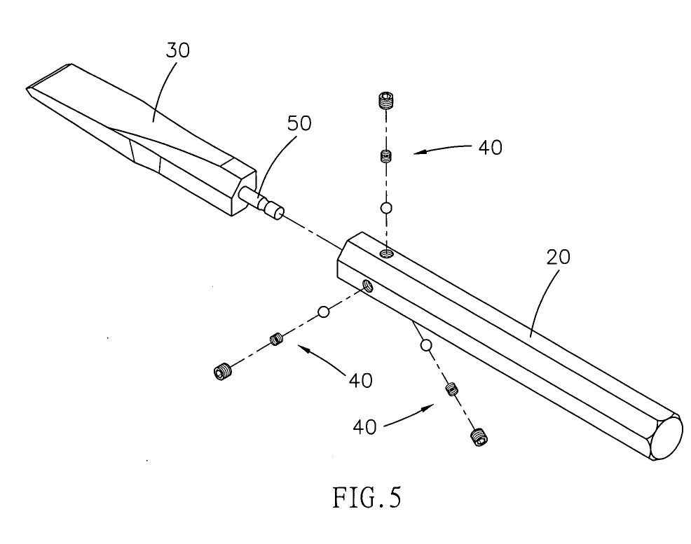

Referring to the drawings and initially to FIGS. 2-5, a chisel in accordance with the preferred embodiment of the present invention comprises a handle 20, a tip 30 removably mounted on the handle 20, an insertion rod 50 secured to the tip 30 and inserted into the handle 20, and at least one positioning unit 40 mounted on the handle 20 and releasably urged on the insertion rod 50 to releasably position the insertion rod 50 on the handle 20 so that the tip 30 is removably mounted on the handle 20.

The handle 20 is a substantially hexagonal rod and has an end portion formed with an axially extended slot 21. The end portion of the handle 20 has a periphery formed with at least one radially arranged tapered hole 22 communicating with the slot 21 to receive the positioning unit 40. The tapered hole 22 of the handle 20 has a relatively narrower inner portion and a relatively wider outer portion.

The tip 30 has an end portion formed with a screw bore 31.

The insertion rod 50 has a first end inserted into the slot 21 of the handle 20 and a second end formed with an outer thread 52 screwed into the screw bore 31 of the tip 30. The first end of the insertion rod 50 is formed with an annular locking groove 51.

The positioning unit 40 includes a locking ball 41 detachably locked in the locking groove 51 of the insertion rod 50 to retain the insertion rod 50 on the handle 20, a retaining screw 43 secured in the handle 20, and an elastic member mounted between the retaining screw 43 and the locking ball 41 to push the locking ball 41 toward the locking groove 51 of the insertion rod 50. The retaining screw 43 is removably mounted in the tapered hole 22 of the handle 20 and partially protruded outward from the tapered hole 22 of the handle 20.

In the preferred embodiment of the present, the chisel comprises three positioning units 40 arranged on the periphery of the handle 20 and equally distant from each other, and the end portion of the handle 20 has three tapered holes 22 to receive the positioning units 40. The three tapered holes 22 of the handle 20 are equally distant from each other.

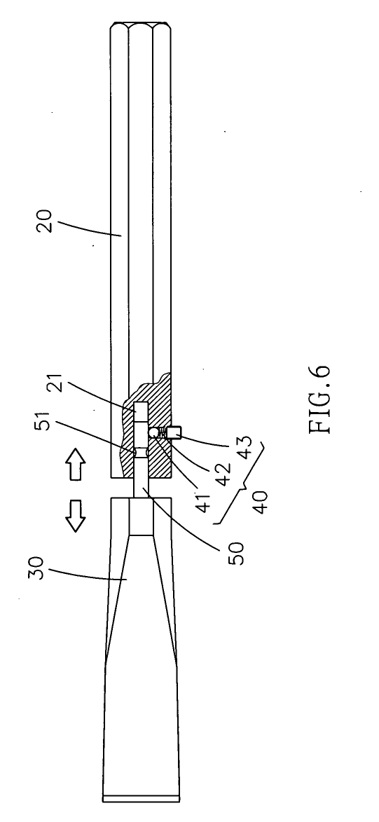

Referring to FIG. 6, when the tip 30 is pulled outward relative to the handle 20, the locking ball 41 is biased to detach from the locking groove 51 of the insertion rod 50 to release the insertion rod 50 from the handle 20, so that the tip 30 can be removed from the handle 20.

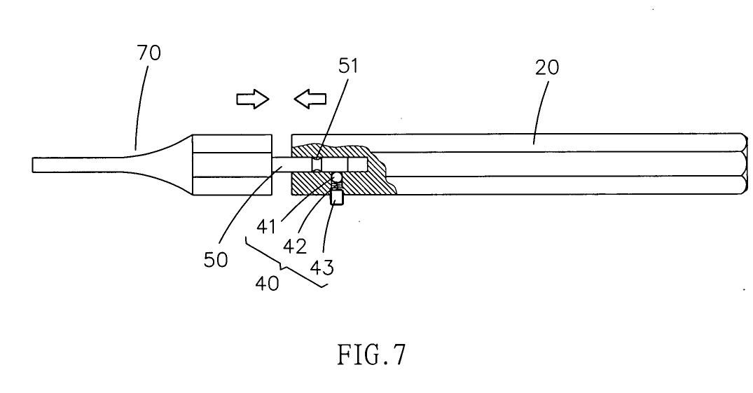

Referring to FIG. 7, when another tip 70 is pushed toward the handle 20, the insertion rod 50 is inserted into the slot 21 of the handle 20 until the locking groove 51 of the insertion rod 50 is aligned with the locking ball 41. Thus, the locking ball 41 is locked in the locking groove 51 of the insertion rod 50 to retain the insertion rod 50 on the handle 20, so that the tip 70 is attached to the handle 20.

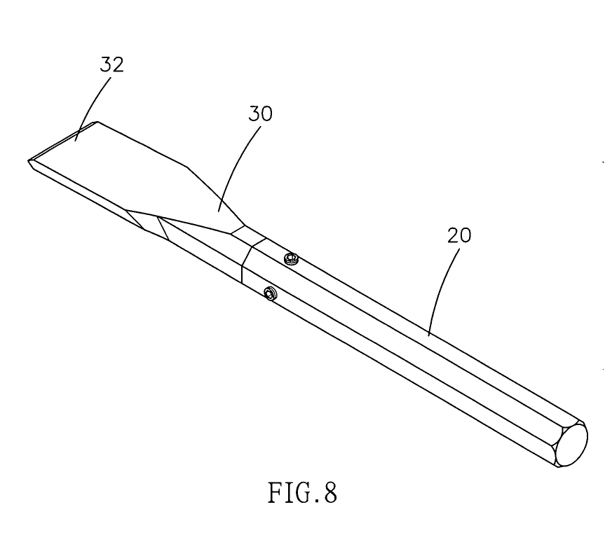

Referring to FIG. 8, the tip 30 has a flat free end 32.

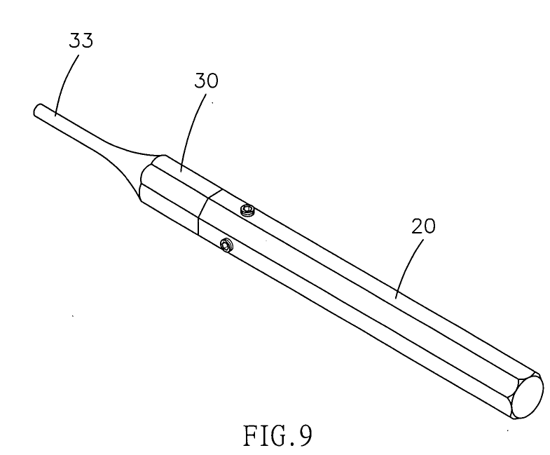

Referring to FIG. 9, the tip 30 has a cylindrical free end 33.

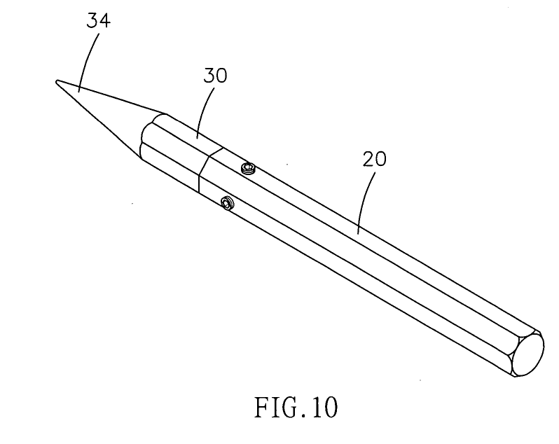

Referring to FIG. 10, the tip 30 has a conical free end 34.

Accordingly, the chisel has replaceable tips, so that the handle can co-operate with tips of different types, thereby facilitating a user operating the chisel, and thereby enhancing the working efficiency. In addition, the user only has to carry a handle and a plurality of tips to construct the chisel without having to carry multiple chisels, thereby greatly decreasing the weight.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A chisel, comprising:
a handle;
a tip removably mounted on the handle;
an insertion rod secured to the tip and inserted into the handle;
at least one positioning unit mounted on the handle and releasably urged on the insertion rod to releasably position the insertion rod on the handle so that the tip is removably mounted on the handle.

2. The chisel in accordance with claim 1, wherein the handle has an end portion formed with an axially extended slot.

3. The chisel in accordance with claim 2, wherein the end portion of the handle has a periphery formed with at least one radially arranged tapered hole communicating with the slot to receive the positioning unit.

4. The chisel in accordance with claim 3, wherein the tapered hole of the handle has a relatively narrower inner portion and a relatively wider outer portion.

5. The chisel in accordance with claim 2, wherein the insertion rod has a first end inserted into the slot of the handle.

6. The chisel in accordance with claim 5, wherein the tip has an end portion formed with a screw bore, and the insertion rod has a second end formed with an outer thread screwed into the screw bore of the tip.

7. The chisel in accordance with claim 5, wherein the first end of the insertion rod is formed with an annular locking groove.

8. The chisel in accordance with claim 7, wherein the positioning unit includes a locking ball detachably locked in the locking groove of the insertion rod to retain the insertion rod on the handle, a retaining screw secured in the handle, and an elastic member mounted between the retaining screw and the locking ball to push the locking ball toward the locking groove of the insertion rod.

9. The chisel in accordance with claim 8, wherein the retaining screw is removably mounted in the tapered hole of the handle.

10. The chisel in accordance with claim 8, wherein the retaining screw is partially protruded outward from the tapered hole of the handle.

11. The chisel in accordance with claim 3, wherein the chisel comprises three positioning units arranged on the periphery of the handle, and the end portion of the handle has three tapered holes to receive the positioning units.

12. The chisel in accordance with claim 11, wherein the positioning units are and equally distant from each other.

13. The chisel in accordance with claim 11, wherein the three tapered holes of the handle are equally distant from each other.

14. The chisel in accordance with claim 1, wherein the handle is a substantially hexagonal rod.

15. The chisel in accordance with claim 1, wherein tip has a flat free end.

16. The chisel in accordance with claim 1, wherein the tip has a cylindrical free end.

17. The chisel in accordance with claim 1, wherein the tip has a conical free end.
